(19) United States
(12) Patent Application Publication
(10) Pub. No.: US 2016/0214858 A1
(43) Pub. Date: Jul. 28, 2016

(54) MULTI-ZONE DEHYDROGENATION REACTOR AND BALLASTING SYSTEM FOR STORAGE AND DELIVERY OF HYDROGEN

(71) Applicant: AIR PRODUCTS AND CHEMICALS, INC., Allentown (PA)

(72) Inventors: Alan Charles COOPER, Macungie, PA (US); Robert Gregory WOLF, Hackettstown, NJ (US); Demos Cruz PAPPAS, Houston, TX (US)

(21) Appl. No.: 15/021,105

(22) PCT Filed: Oct. 20, 2014
(86) PCT No.: PCT/US2014/061358

§ 371 Date: Mar. 10, 2016

Related U.S. Application Data
(60) Provisional application No. 61/893,503, filed on Oct. 21, 2013.

(51) Int. Cl. C01B 3/26

(52) U.S. Cl. CPC C01B 3/26; C01B 2203/0277; C01B 2203/1211

(57) ABSTRACT

A process and system for a process for releasing hydrogen from a hydrogenated organic carrier. The process including providing a reactor system comprising a first reaction zone and a second reaction zone, the first reaction zone having a first reaction condition and the second reaction zone having a second reaction condition, wherein the first reaction condition and the second reaction condition are different. A ballast system and method are also disclosed. The ballast system includes at least one vessel containing metal hydride capable of selectively storing hydrogen from the hydrogen-containing stream and one or both of selectively providing hydrogen to one or both of a hydrogen load or the dehydrogenation system.

### BACKGROUND OF THE INVENTION

The invention relates to the field of hydrogen storage systems and in particular to a process of releasing the stored hydrogen from hydrogen carrier compositions (“carrier”) for use in a hydrogen-consuming device, such as fuel cell or internal combustion engine. Disclosed are methods and apparatus for dehydrogenation of a carrier to supply hydrogen and a ballasting system for controlling a hydrogen supply.

Hydrogen can be stored as a compressed gas, as liquid hydrogen at cryogenic temperatures and as the captured or contained gas in various carrier media, examples of which are metal hydrides [for examples see: G. Sandrock, J. Alloys and Compounds, 293-295, 877 (1999)], high surface area carbon materials [for examples see: A. C. Dillon and M. J. Heben, Appl. Phys. A 72, 133 (2001)], and metal-organic framework materials [A. G. Fong-Way et al., J. Am. Chem. Soc. 128, 3494 (2006)]. In metal hydrides the hydrogen is dissociatively absorbed while for the latter two material classes, which have only demonstrated significant capacities at low temperatures, the hydrogen molecule remains intact on adsorption. Generally, the contained hydrogen in such carrier media can be released by raising the temperature and/or lowering the hydrogen pressure.

Hydrogen can also be stored by means of a catalytic reversible hydrogenation of unsaturated, usually aromatic, organic compounds, such as benzene, toluene or naphthalene. The utilization of organic hydrogen carriers, sometimes referred to as “organic hydrides”, for hydrogen storage and delivery has been described in the context of a hydrogen powered vehicle [N. F. Grunenfelder et al. Int. J. Hydrogen Energy 14, 579 (1989)]. Other examples of the dehydrogenation of organic hydrogen carriers are the dehydrogenation of decalin under “wet-dry multiphase conditions” [N. Kariga et al. Applied Catalysis A, 233, 91 (2002)], and dehydrogenation of methylcyclohexane to toluene (A. S. Kesten, U.S. Pat. No. 4,567,033; hereby incorporated by reference). The dehydrogenation of a cyclic alkane (e.g., decalin) to the corresponding aromatic compound (naphthalene) is an endothermic reaction requiring an input of heat which is the dehydrogenation reaction enthalpy, ΔH. For the test vehicle described by N. F. Grunenfelder et al., some of the required ΔH comes from the engine's exhaust system and the remainder is supplied by a combustion of hydrogen. In U.S. Pat. No. 4,567,033, Kesten likewise points to the need of supplying heat for the catalytic dehydrogenation of methylcyclohexane to toluene which is accomplished by a combustion of a considerable portion of the product hydrogen.

U.S. Pat. Nos. 7,101,530 and 7,351,395 (hereby incorporated by reference in their entirety) describe methods for hydrogen storage using carriers via a reversible hydrogenation of pi-conjugated substrates. The disclosed substrates comprise cyclic organic molecules containing nitrogen or oxygen heteroatoms, which have a lower enthalpy or heat of dehydrogenation than benzene, toluene and naphthalene. The “spent” or at least partially dehydrogenated aromatic or pi-conjugated substrates can be regenerated in a spontaneous, exothermic catalytic reaction with hydrogen.

German Patent Publications DE102010038490A1 and DE102010038491A1 (hereby incorporated by reference in their entirety) disclose hydrogen fuel supply devices for internal combustion engines. The methods and systems disclosed are directed to integrations with an internal combustion engine having waste heat that is hot enough to drive a dehydrogenation reaction The system provided does not address processes that do not have sufficient waste heat to drive dehydrogenation.

U.S. Pat. No. 7,485,161 (hereby incorporated by reference in its entirety) describes a process and system for delivery of hydrogen by dehydrogenation of an organic compound from its hydrogenated state in a microchannel reactor. No ballasting or purifying of hydrogen stream is disclosed, nor are different reaction conditions of temperature or catalyst in different zones of the dehydrogenation reactor disclosed. Microchannel reactors also have a high weight-to-reaction ratio such that mobile applications may not be able to afford the weight of a microchannel reactor. Microchannel reactors may also require a heat-exchange fluid which can add to the weight of the reactor unless the carrier itself is used as a heat-exchange fluid.

The chemical dehydrogenation of carriers is known to produce unwanted by-products which may serve as inert species or contaminants to a fuel cell or down-stream chemical or electrochemical process. The production of unwanted by-products may be mitigated by the selection of catalyst, limiting reaction temperatures and furthermore since the carriers transition through several chemical intermediates, the selectivity of the catalysts and appropriate temperature regime may also be a function of the state of partial dehydrogenation. Other processes for downstream hydrogen processing and storage include membranes (e.g. palladium), hydrogen pressure swing adsorbers (PSA), vacuum swing adsorbers (VSA) or empty vessels. A palladium membrane is effective in purifying the hydrogen stream but cannot store the hydrogen gas, has limited permeation rates, and is expensive. The hydrogen PSA operates at conditions that may also require additional hydrogen compression which would add additional weight and volume to the system. Lastly, using an empty vessel for storage would require a much larger volume to store an equivalent amount of hydrogen while also losing the ability to purify the product hydrogen gas.

If the carrier transitions between several molecular species as intermediates during dehydrogenation each intermediate will have a different boiling point during the dehydrogenation process. Therefore, reactor temperature limits set by the boiling point limit may be different during different stages of dehydrogenation.

The foregoing patents and patent applications are hereby incorporated by reference in their entirety.

There is a need in this art for a weight and volume-efficient liquid phase dehydrogenation reactor capable of delivering hydrogen instantaneously or near instantaneously. In response to hydrogen load shifting and at reactor startup, at purities suitable for use in fuel cells, with the potential scaling down to relatively small power-scales, such as power-scales at or below 1 kW.

### BRIEF SUMMARY OF THE INVENTION

The instant invention solves problems in this art by providing a multi-zone dehydrogenation reactor using catalytic dehydrogenation with integral hydrogen ballast. Also provided is a ballast system for a dehydrogenation system utilizing metal hydride for selective hydrogen storage that permits rapid reactor startup and purification of hydrogen-containing streams. In addition, in another embodiment, when a metal hydride with a pressure plateau in-between the reactor's maximum operating pressure and the desired output pressure, the entire system can run on the passive pressurization available from the dehydration reaction.

An aspect of the invention relates to a process for releasing hydrogen from a hydrogenated organic carrier. The process includes the following:
(a) providing a reactor system comprising a first reaction zone and a second reaction zone, the first reaction zone having a first reaction condition and the second reaction zone having a second reaction condition;
(b) introducing said hydrogenated organic carrier in liquid form to the first reaction zone of the reactor system and exposing the hydrogenated organic carrier to the first reaction condition;
(c) partially dehydrogenating said organic carrier in the first reaction zone of the reactor system whereby said dehydrogenating produces hydrogen and a liquid phase partially dehydrogenated organic carrier;
(d) separating hydrogen and the partially dehydrogenated organic carrier;
(e) introducing the partially dehydrogenated organic carrier into the second reaction zone and exposing the partially dehydrogenated organic carrier to the second reaction condition;
(f) dehydrogenating the partially dehydrogenated organic carrier in the second reaction zone of the reactor whereby said dehydrogenating produces hydrogen and a liquid phase dehydrogenated organic carrier;
(g) separating hydrogen and said liquid phase dehydrogenated organic carrier;
(h) introducing the hydrogen from the first reaction zone and the second reaction zone to a ballast system;
wherein the first reaction condition and the second reaction condition are different.

Another aspect of the invention includes a dehydrogenation system for releasing hydrogen from a hydrogenated organic carrier. The system includes a reactor system comprising a first reaction zone and a second reaction zone, the first reaction zone being arranged and disposed to provide a first reaction condition and the second reaction zone being arranged and disposed to provide a second reaction condition. The first reaction condition and the second reaction condition are different. The first reaction zone of the reactor system is arranged and disposed to partially dehydrogenate a liquid phase hydrogenated organic carrier in the first reaction zone to form hydrogen and a liquid phase partially dehydrogenated organic carrier. The second reaction zone of the reactor system is arranged and disposed to dehydrogenate the liquid phase partially dehydrogenated organic carrier in the second reaction zone to form hydrogen and a liquid phase dehydrogenated organic carrier. The system further includes a ballast system is arranged and disposed to receive the hydrogen from the first reaction zone and the second reaction zone.

Another aspect of the invention includes a dehydrogenation system for releasing hydrogen from a hydrogenated organic carrier. The system includes a reactor system comprising a reaction zone, the reaction zone being arranged and disposed to provide a reaction condition, the reaction condition including an elevated temperature provided by a heater. The reaction zone of the reactor system is arranged and disposed to dehydrogenate a liquid phase hydrogenated organic carrier in the reaction zone to form hydrogen and a liquid phase dehydrogenated organic carrier. The system further includes a ballast system having at least one vessel containing metal hydride capable of selectively storing hydrogen from the hydrogen-containing stream and being arranged and disposed to provide hydrogen to one or both of a hydrogen load or the dehydrogenation reactor system.

Another aspect of the invention includes a process for providing a hydrogen-containing stream. The process including the following:
(a) forming a hydrogen-containing stream with a dehydrogenation reactor system;
(b) providing the hydrogen-containing stream to a ballast system having at least one vessel containing metal hydride;
(c) selectively storing hydrogen with the metal hydride from the hydrogen-containing steam;
(d) selectively providing the hydrogen to one or both of a hydrogen load or the dehydrogenation reactor system.

Another aspect of the invention includes a dehydrogenation system for providing a hydrogen-containing stream. The system includes a dehydrogenation reactor system arranged and disposed to dehydrogenate a carrier to form a hydrogen-containing stream. The system further includes a ballast system having at least one vessel containing metal hydride capable of selectively removing and storing hydrogen from the hydrogen-containing stream and being arranged and disposed to provide hydrogen to one or both of a hydrogen load or the dehydrogenation reactor system.

Other features and advantages of the present invention will be apparent from the following more detailed description of the preferred embodiment, taken in conjunction with the accompanying drawings which illustrate, by way of example, the principles of the invention.

### BRIEF DESCRIPTION OF SEVERAL VIEWS OF THE DRAWINGS

FIG. 1 is a schematic view of a dehydrogenation system.

FIG. 2 is a schematic view of a dehydrogenation reactor system.

FIG. 3 is a schematic view of a ballast system.

FIG. 4 is a dehydrogenation system, according to an exemplary embodiment.

FIG. 5 is a dehydrogenation system, according to an exemplary embodiment.

FIG. 6 shows total reactor volume vs. residence time for multi-zone reactor systems, according to embodiments.

FIG. 7 shows to concentration of methane vs. time for a ballast system according to various operational modes.

FIGS. 8A, 8B and 8C shows hydrogen discharge from three ballast vessel systems, according to embodiments of the invention.

FIG. 9 shows the relationship between the time from 0-25% conversion to the time between 25-50% conversion for multiple catalysts during the dehydrogenation of perhydro-N-ethylcarbazole.

FIG. 10 shows the relationship between the time from 50-75% conversion to the time between 25-50% conversion for multiple catalysts during the dehydrogenation of perhydro-N-ethylcarbazole.

Wherever possible, the same reference numbers will be used throughout the drawings to represent the same parts.

### DETAILED DESCRIPTION OF THE INVENTION

The instant invention relates to processes and systems for hydrogen delivery and storage by catalytic dehydrogenation of a liquid organic carrier. In addition, the instant invention includes a ballasting system for selectively storing hydrogen with a metal hydride that permits rapid reactor startup and purification of hydrogen-containing streams. One embodiment is a multi-zone dehydrogenation reactor that takes in fresh liquid organic hydrogen carrier and discharges hydrogen and dehydrogenated liquid. The present invention provides a hydrogen storage and delivery system capable of operating via a number of different control modes to provide hydrogen at varying rates and dehydrogenation to a pre-determined extent. The reactor stores hydrogen in an optional ballast which provides hydrogen to both pre-heat the reactor and also to fast-start the hydrogen supplied to a hydrogen load, such as an external fuel cell. In addition, the ballast, according to the present invention, allows purification of the hydrogen stream prior to delivery as a product stream.

A hydrogen-containing stream, as utilized herein, includes a stream that contains gaseous hydrogen. This stream can be high purity hydrogen, hydrogen capable of being fed to the fuel cell, or “dirty” hydrogen, a hydrogen stream with a contaminant level too high to be used by the fuel cell. When a hydrogen stream is provided to a fuel cell, the hydrogen stream must be compatible with the required input specifications of a hydrogen fuel cell. For example, the hydrogen stream will typically contain a sub-ppm level of fuel cell poisons such as sulfur-containing compounds or carbon monoxide and an allowed amount of inert species such as methane, ethane or nitrogen in the range of tens of ppm.

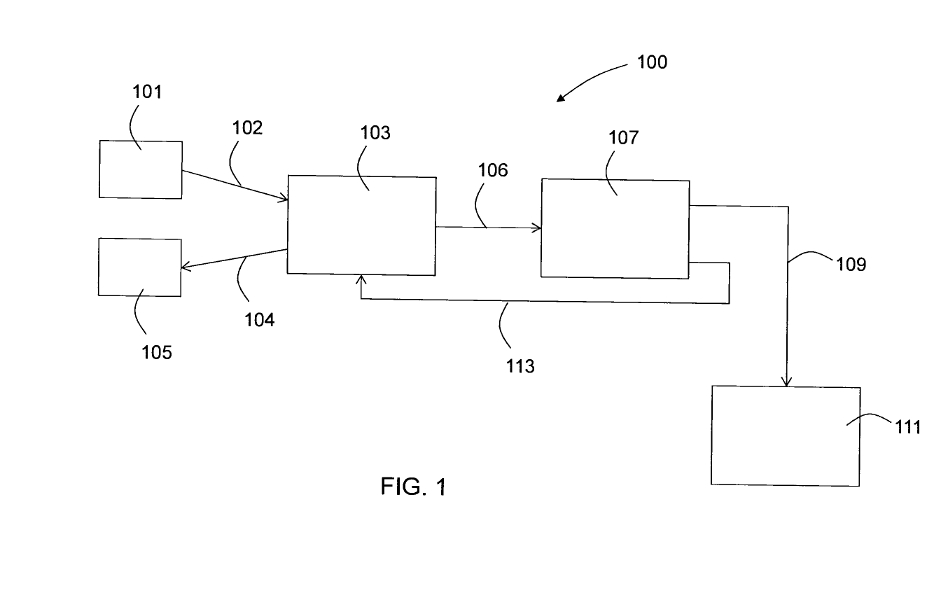

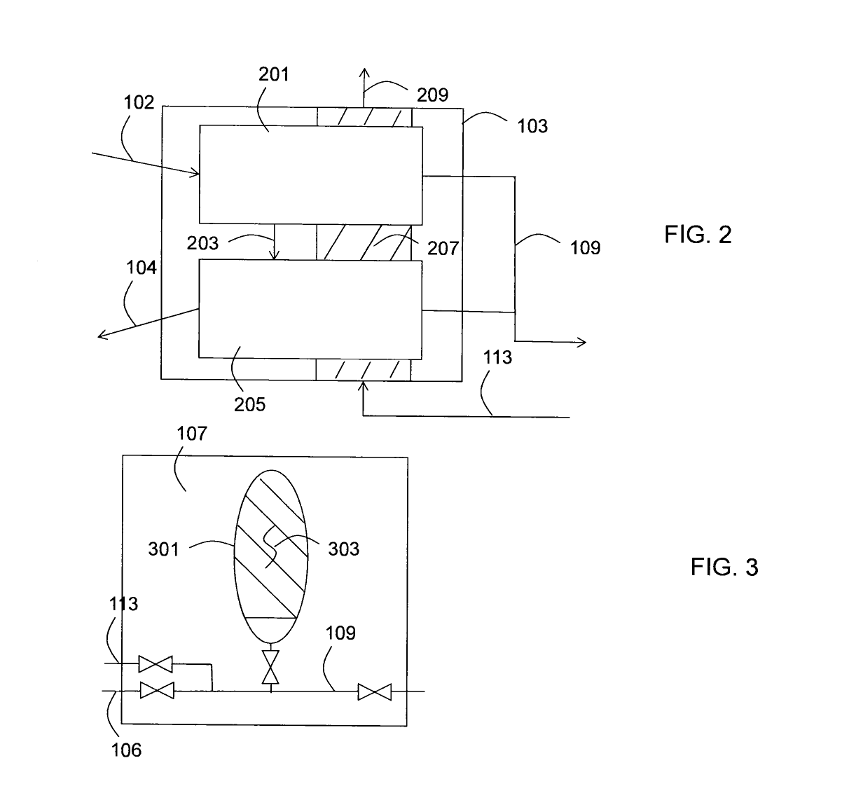

FIG. 1 shows a dehydrogenation system 100 for producing a hydrogen product gas 109 for a hydrogen load 111. The dehydrogenation system 100 includes a dehydrogenation reactor system 103 and a ballast system 107. A hydrogenated organic carrier 102 is provided from a liquid organic hydrogen carrier source 101 and is catalytically dehydrogenated by the dehydrogenation reactor system 103 to provide a dehydrogenated organic carrier 104. The dehydrogenated organic carrier 104 is provided to dehydrogenated storage 105. In addition to the dehydrogenated organic carrier 104, the dehydrogenation reactor system 103 also provides a hydrogen-containing stream 106 to the ballast system 107. The ballast system 107 provides hydrogen product gas 109 to the hydrogen load 111. In addition, the ballast system 107 provides a purge stream 113 to the dehydrogenation reactor system 103. The purge stream 113 is utilized by the dehydrogenation reactor system 103 to provide heat through combustion or other suitable methods (see for example FIG. 2). The hydrogen load 111 as shown in FIG. 1 is a device or system that utilizes hydrogen as a fuel or feed. In one embodiment, the hydrogen load 111 is a fuel cell, internal combustion engine, gas turbines, chemical processes such as hydrogenation reactions or combustion processes such as glass production or atmospheres for enhanced thermal conductivity such as for generator windings or incorporation in small quantities with natural-gas for pipeline distribution. While dehydrogenation system 100 is shown with the ballast system 107, in certain embodiments, the ballast system 107 may be omitted when the hydrogen load 111 is less sensitive to impurities or delivery pressure. Alternate ballast/purification systems 107 include a palladium or other membrane, a hydrogen pressure swing adsorber (PSA), vacuum swing adsorber, and an empty vessel.

Hydrogenated organic carrier 102 fed to the dehydrogenation reactor system 103 includes any organic compound capable of catalytic dehydrogenation to release hydrogen gas. In one embodiment, the hydrogenated organic carrier 102 includes pi-conjugated (often written in the literature using the Greek letter π) molecules in the form of liquid organic compounds, as disclosed in U.S. Pat. No. 7,429,372, which is hereby incorporated by reference in its entirety. These pi-conjugated substrates are characteristically drawn with a sequence of alternating single and double bonds. In molecular orbital theory, the classically written single bond between two atoms is referred to as an σ-bond, and arises from a bonding end-on overlap of two dumbbell shaped “p” electron orbitals. It is symmetrical along the molecular axis and contains the two bonding electrons. In a “double” bond, there is, in addition, a side-on overlap of two “p” orbitals that are perpendicular to the molecular axis and is described as a pi-bond (or “π”-bond). It also is populated by two electrons but these electrons are usually less strongly held, and more mobile. The consequence of this is that these pi-conjugated molecules have a lower overall energy, i.e., they are more stable than if their pi-electrons were confined to or localized on the double bonds.

In one embodiment, the hydrogenated organic carrier 102 is a pi-conjugated substrate, including aromatic compounds with one or two rings, polycyclic aromatic hydrocarbons, pi-conjugated substrates with nitrogen heteroatoms, pi-conjugated substrates with heteroatoms other than nitrogen, pi-conjugated organic polymers or oligomers, ionic pi-conjugated substrates, pi-conjugated monocyclic substrates with multiple nitrogen heteroatoms, pi-conjugated substrates with at least one triple-bonded group and selected fractions of coal tar or pitch that have as major components the above classes of pi-conjugated substrates, or any combination of two or more of the foregoing, as described in U.S. Pat. No. 7,485,161, which is hereby incorporated by reference in its entirety. The liquid-phase hydrogenated organic carrier 102 useful according to this invention may also have various ring substituents, such as -n-alkyl, -branched-chain alkyl, -alkoxy, -nitrile, -ether and -polyether, which may improve some properties, such as reducing the melting temperature of the substrate while at the same time not adversely interfering with the hydrogenation/dehydrogenation equilibrium. Preferably, any of these substituent groups would have 4 or less carbons. Suitable organic compounds that can be hydrogenated for use as a hydrogen carrier include aromatic hydrocarbons selected from the group consisting of benzene, toluene, naphthalene, anthracene, pyrene, perylene, fluorene, indene, and any combination of two or more of the foregoing. Further suitable organic compounds that can be hydrogenated for use as a hydrogen carrier include N-methylcarbazole, N-ethylcarbazole, N-n-propylcarbazole, carbazole, N-iso-propylcarbazole, and perhydro-fluorene.

FIG. 2 shows a dehydrogenation reactor system 103, as shown in FIG. 1, according to an embodiment. As shown in FIG. 1, the dehydrogenation reactor system 103 receives the hydrogenated organic carrier 102 from a liquid organic hydrogen carrier source 101. The hydrogenated organic carrier 102 is provided to a first reaction zone 201. The first reaction zone 201 includes a catalyst and temperature suitable for a desired partial catalytic dehydrogenation of the hydrogenated organic carrier 102. The partially dehydrogenated organic carrier 203 is provided to a second reaction zone 205 where the partially dehydrogenated organic carrier 203 is further catalytically dehydrogenated to form the dehydrogenated organic carrier 104. As utilized herein, the term “dehydrogenated” and grammatical variations thereof is not intended to be limited to fully dehydrogenated compounds, but may include partially dehydrogenated compounds. A heater 207 is provided and is in a heat exchange relationship with the first reaction zone 201 and the second reaction zone 205 to provide heat of reaction. Heater 207 is fed with purge stream 113 from the ballast system 107 (see FIG. 1) and oxygen source, such as air, to combust the purge stream 113 to provide heat for the dehydrogenation reactions. Heater 207 may include catalysts to promote the flameless combustion of hydrogen and one or more reaction by-products and or hydrocarbons. In one embodiment, the purge steam 113 is supplemented or replaced with an alternate gas or fuel stream, such as, but not limited to, methanol or propane. In one embodiment, heater 207 further utilizes heat exchange from the dehydrogenated organic carrier 104. In one embodiment, the hydrogenated organic carrier 102 may be utilized as a heat exchange fluid to provide the temperatures for catalytic dehydrogenation to the first reaction zone 201 and/or the second reaction zone 205. Exhaust 209 vents the products of combustion from the dehydrogenation reactor system 103. The first reaction zone 201 and the second reaction zone 205 have a first and second reaction condition that differ from one another. The reaction conditions include one or both of reaction temperature and catalyst. In one embodiment, the first reaction condition and the second reaction condition differ in catalyst. In another embodiment, the first reaction condition and the second reaction condition differ in temperature. In another embodiment, the first reaction condition and the second reaction condition differ in catalyst and temperature. The reaction conditions present in the first reaction zone 201 and the second reaction zone 205 are catalysts and temperatures selected to dehydrogenation reactions dominant in that zone to provide a desired overall dehydrogenation for the dehydrogenation reactor system 103. While the above has been described with a first reaction zone 201 and a second reaction zone 205, any number of zones greater than two may also be used.

The temperature for use in the first reaction zone 201 and the second reaction zone 205 is a suitable catalytic dehydrogenation temperature. The temperature in each of the first reaction zone 201 and the second reaction zone 205 are provided to increase the dehydrogenation rate and decrease the required volume of the reactor. In one embodiment, the total volume of the first reaction zone and the second reaction zone is less than the volume of a single vessel of the same dehydrogenation efficiency. As utilized herein, dehydration efficiency is an overall dehydrogenation rate corresponding to a maximum or near maximum rate of hydrogen production while also providing a rate of production of unwanted by-products at a minimum or near minimum rate. Typically the temperature in the reactor will range between 25-300° C. but preferably between 180-240° C. For example, a suitable temperature for a palladium catalyst is about 230° C. in the first reaction zone 201 and 240° C. in the second reaction zone 205. An upper temperature limit for the first reaction zone is based on the boiling point of the carrier. For example, a carrier comprising perhydrofluorene has a boiling point of about 250° C. at ambient pressure, corresponding to a temperature limit of the first zone of about 250° C. unless higher pressures are used. As the dehydrogenation reaction occurs, the boiling point of the carrier increases, and this allows the second zone to operate at an increased temperature, for example for partially dehydrogenated perhydrofluorene, a temperature of about 240° C. This temperature limitation works for various catalysts, including, but not limited to palladium-containing catalysts or platinum-containing catalysts. The production of unwanted reaction byproducts may be increased with certain catalysts and at higher temperatures. Therefore, since the temperature may need to be higher in the second reactor, a catalyst with higher selectivity may be necessary to suppress the rate of production of unwanted byproducts.

The catalyst for use in the first reaction zone 201 and the second reaction zone 205 is a dehydrogenation catalyst capable of dehydrogenating the hydrogenated organic carrier 102. Suitable dehydrogenation catalysts include solid catalysts, in a structured or unstructured form. In one embodiment, the catalyst is present as a slurry. In one embodiment, the catalyst is integral to an agitator in one or both of the first reaction zone 201 and the second reaction zone 205. In one embodiment, the catalyst is a structured catalyst with features or contours that promote bubble nucleature via low-pressure zones. In one embodiment, the catalyst is a structure providing a desirable catalytic surface, such as, but not limited to, a precious metal surface over a non-precious metal core.

Suitable catalyst compositions include, for example, finely divided or nanoparticles of metals, and their oxides and hydrides, of Groups 4, 5, 6 and 8, 9, 10 of the Periodic Table, according to the International Union of Pure and Applied Chemistry. Preferred are titanium, zirconium of Group 4; tantalum and niobium of Group 5; molybdenum and tungsten of Group 6; iron and ruthenium of Group 8; cobalt, rhodium and iridium of Group 9; and nickel, palladium and platinum of Group 10 of the Periodic Table, according to the International Union of Pure and Applied Chemistry. Of these the most preferred being zirconium, tantalum, nickel, palladium, platinum, vanadium, their oxide precursors (such as PtO₂) and mixtures, as appropriate. These metals may be used as catalysts and catalyst precursors as metals, metal oxides and metal hydrides in their finely divided powder form, nanoparticles, or as skeletal structures, such as platinum black or Raney nickel, or well-dispersed on carbon, alumina, silica, zirconia or other medium to high surface area supports, preferably carbon or alumina. Typical loadings of catalytic metal on inert supports are from about 1-50% by weight or about 5-20% by weight. Specific examples of dehydrogenation catalysts include Raney nickel, platinum black, palladium powder, 5% platinum on carbon, and a mixture of 4% platinum and 1% rhenium on aluminum oxide as detailed in U.S. Department of Energy Office of Scientific and Technical Information (OSTI) report #1039432 (April 2012).

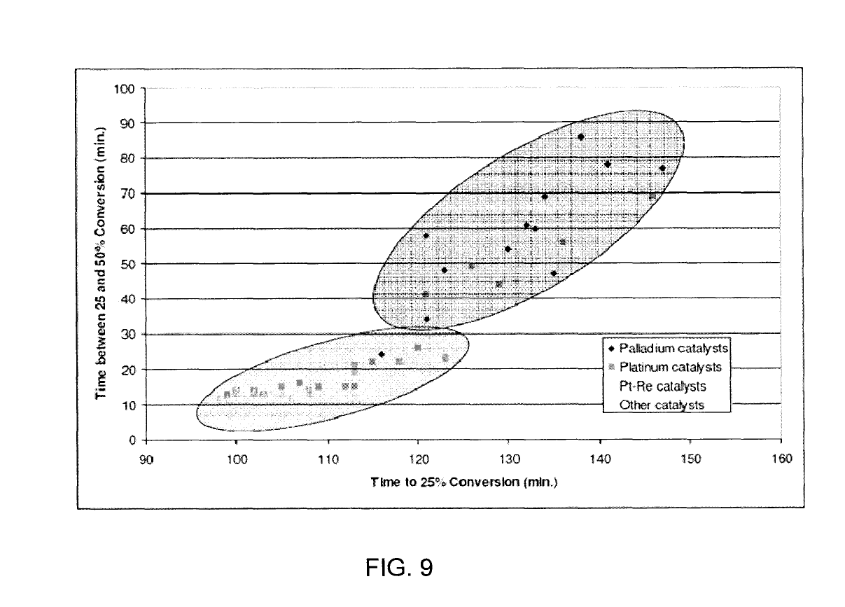

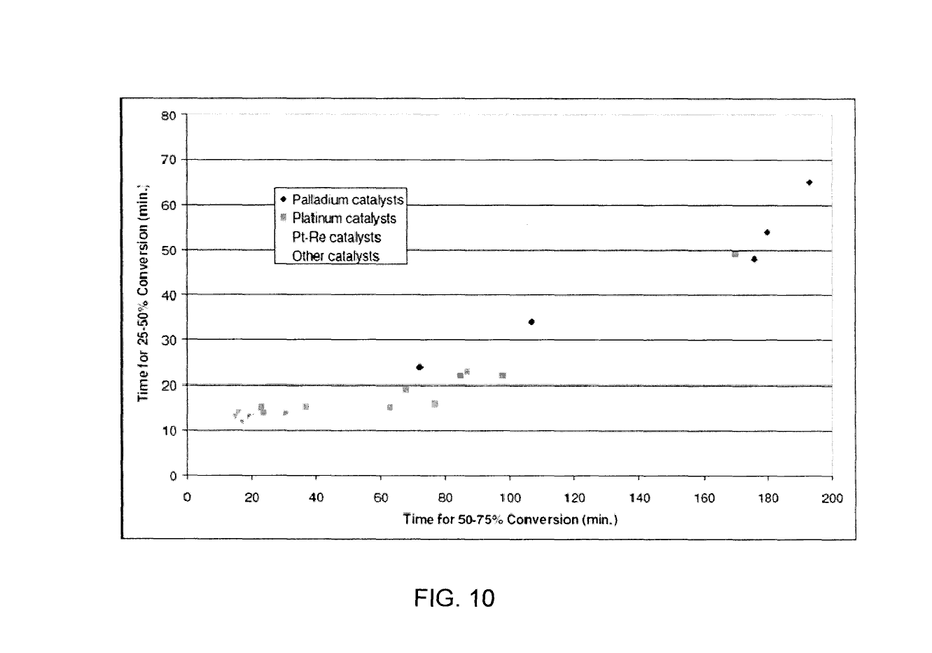

In one embodiment, the choice of catalyst in the first reaction zone can be based on how quickly it allows the reaction to proceed, while the choice of catalyst in the second reaction zone can be based on the selectivity of the dehydrogenation reaction and desired purity of the hydrogen product. The following embodiments are based on determining which catalyst should be implemented in which reaction zone. FIG. 9 shows the relationship between the time from 0-25% conversion to the time between 25-50% conversion for multiple catalysts during the dehydrogenation of perhydro-N-ethylcarbazole. There is a clear distinction between the speeds of platinum-based catalysts and palladium-based catalysts. The platinum-based catalysts in general take less time to achieve higher conversions, this suggests platinum is a good catalyst for the first reaction zone. FIG. 10 shows the relationship between the time from 50-75% conversion to the time between 25-50% conversion. This graph also shows that platinum based catalysts perform faster in this range, however, since the temperature in the second reaction zone can occur at a different temperature, the temperature can be raised to allow the rate in the second zone to become similar to that of the first reactor zone.

When comparing platinum and palladium for the second reactor zone it is beneficial to look at the impurities that are produced. The following tables show the impurities produced by palladium and platinum catalysts during the dehydrogenation of perhydro-N-ethylcarbazole (PH-NEC).

Table 1A shows the temperature and hydrogen flow rate at the time when the samples were analyzed by gas chromatography.

TABLE 1A
DEHYDROGENATION OF PH-NEC
WITH PALLADIUM ON ALUMINA

| | | Methane | Ethane |
|---|---|---|---|
| Temp | H2 Flow | Conc. | Conc. |
| (° C.) | (sccm) | (ppm) | (ppm) |
| 144 | 5 | 177 | 2 |
| 147 | 6.4 | 164 | 10 |
| 149 | 7.3 | 137 | 19 |
| 152 | 8.1 | 99 | 31 |
| 154 | 9 | 80 | 34 |
| 197 | 45 | | 1 |
| 197 | 39 | | 13 |
| 197 | 35 | | 23 |
| 197 | 30 | | 23 |
| 197 | 26 | | 25 |
| 197 | 5 | | 44 |
| 197 | 4.6 | | 47 |
| 197 | 4.4 | | 48 |
| 197 | 4.1 | | 47 |
| 197 | 3.9 | | 48 |

Table 1B shows the temperature and hydrogen flow rate at the time when the samples were analyzed by gas chromatography.

TABLE 1B
DEHYDROGENATION OF PH-NEC
WITH PLATINUM ON ALUMINA

| | | Methane | Ethane |
|---|---|---|---|
| Temp | H2 Flow | Conc. | Conc. |
| (° C.) | (sccm) | (ppm) | (ppm) |
| 144 | 5 | 196 | 44 |
| 147 | 6.4 | 194 | 163 |
| 153 | 7.3 | 188 | 374 |
| 155 | 8.1 | 178 | 631 |
| 157 | 9 | 169 | 991 |
| 197 | 58 | | 2723 |
| 197 | 45 | | 2865 |
| 197 | 32.9 | | 3327 |
| 197 | 22.8 | | 4146 |
| 197 | 17.5 | | 5093 |
| 197 | 5 | | 7244 |
| 197 | 4.8 | | 7350 |
| 197 | 5.5 | | 7398 |
| 197 | 4.9 | | 7355 |
| 197 | 4 | | 7343 |

Data contained in Tables 1A and 1B indicate that platinum produces an increasing concentration of contaminants as the temperature in the reactor is increased and as the carrier conversion is increased. The increasing amounts of contaminants lead to issues in purification of the hydrogen stream. In one embodiment, since the second reaction zone is run at an increased temperature, to reduce the total amount of contaminants leaving the reactor effluent, palladium is used in the second reactor zone.

Contamination in the reactor effluent is an issue, particularly when the levels exceed the upper limits allowed for the use in a fuel cell. The hydrogen purity specification for light hydrocarbons, for example, methane and ethane are <10 ppm as detailed in the Society of Automotive Engineers (SAE) standard for hydrogen fuel quality for fuel cell vehicles (SAE J-2719 (2011)). In certain embodiments, when the reactor effluent becomes contaminated, a purification step is required prior to feeding the hydrogen to the fuel cell. In one embodiment for this purification system, metal hydride ballasts are utilized for both storage and hydrogen purification.

In one embodiment, the first reaction zone 201 and the second reaction zone 205 are separate vessels having the independent reaction conditions. In another embodiment, the first reaction zone 201 and the second reaction zone 205 are a unitary vessel with separate zones or areas having independent reaction conditions. In one embodiment, the first reaction zone 201 and the second reaction zone 205 have nominally different sizes in order to balance the dehydrogenation rates. In one embodiment, the second reaction zone 205 is a ‘passive’ zone with a monolith catalyst. Each of the first reaction zone 201 and the second reaction zone 205 may comprise a reactor vessel, such as: i) a tubular device packed with catalyst pellets, ii) a monolith reactor consisting of a parallel array of internally catalyst-coated tubular structures, iii) one of two or more sets of tubular elements or flow conduits of a microchannel reactor, among other reactor types capable of conducting a conversion involving three phases (e.g., solid [catalyst], liquid [feed and dehydrogenated product] and gas [hydrogen], [steam]). While any suitable reactor vessel can be employed, examples of suitable microchannel reactors are shown in U.S. Pat. No. 7,405,338 and U.S. Pat. No. 6,455,830; both hereby incorporated by reference in their entirety. One or both of the first reaction zone 201 and the second reaction zone 205 may include agitation via an agitator, circulator or other suitable device or system. In one embodiment, agitation is provided via an electro-magnetic coupler. In one embodiment, the agitator is configured to provide bubble disengagement. In one embodiment, the agitator is made up of or contains dehydrogenation catalyst. In one embodiment, the agitator has different ‘modes’ to help control the rate and/or fluid-exit from the first reaction zone 201 or the second reaction zone 205. In one embodiment, agitation is provided by ultrasonic energy. In one embodiment, the agitator is configured to provide agitation sufficient to overcome external G-forces where the centripetal force of the spinning liquid compels the liquid to stay away from the gas-liquid separator even as the reactor is undergoing an acceleration such as a vehicle would experience. In one embodiment, the first reaction zone 201 or the second reaction zone 205 also include a centripetal stirring system that also serves as a bubble disengagement zone and G-force mitigation method.

While not specifically visible in FIG. 2, the hydrogenation reactor system 103 includes gas separation of the dehydrogenated organic carrier 104 and the hydrogen gas. Such separation may be provided, for example, by a mechanical ‘frit’ or porous media, by centripetal force from the spinning agitator serving to knock-down bubbles and compel liquid to stay in position while the gas can exit between the bristles of the agitator, by tangential contact and/or incorporating a filter with adsorption properties (such as activated carbonor zeolites), thermal cycles, or pressure cycles.

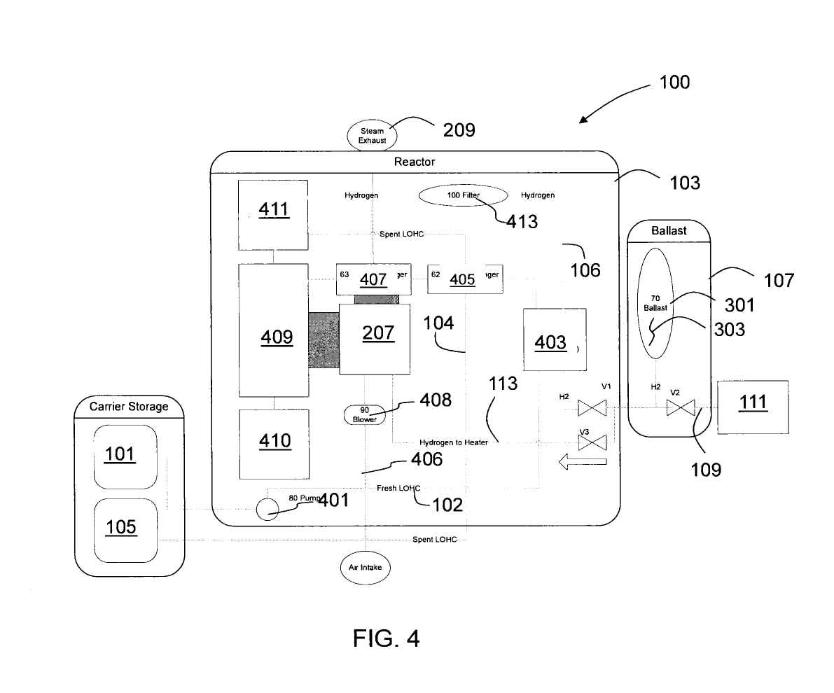

FIG. 3 shows the ballast system 107, as shown in FIG. 1, according to an embodiment. The ballast system 107 provides storage of hydrogen from hydrogen-containing stream 106 to provide either as hydrogen product gas 109 or as purge streams 113 (see FIG. 1). For example, the ballast system 107 may contain a charge of hydrogen capable of buffering enough hydrogen to start up the dehydrogenation reactor system 103. To start up the reactor, purge stream 113 is provided to heater 207 for combustion. In another embodiment, the ballast system 107 may carry enough hydrogen to start both the reactor and provide hydrogen product gas 109 to the hydrogen bad 111 simultaneously. In one embodiment, the ballast system 107 is a pressure swing adsorption (PSA) system. FIG. 3 shows an embodiment wherein the ballast system 107 is a metal hydride selective hydrogen storage system. The ballast system 107 in this embodiment includes a vessel 301 containing metal hydride 303. The metal hydride is arranged within vessel 301 to allow infiltration and storage of gas via absorption, adsorption or any other hydrogen reaction for selective hydrogen storage. For example, the metal hydride may be present as a loose powder supported by a frit or other gas permeable material. As utilized herein, “selective hydrogen storage” means preferential absorption, adsorption or reaction of hydrogen to reversibly bind hydrogen over other compounds that may be present in the gas. Metal hydrides for the ballast system 107 include any suitable hydride complexes or alloys capable of selective hydrogen storage. Suitable metal hydrides, borohydrides, and alanates include but are not limited to, Mg(BH₄)₂, NaBH₄, NaAlH₄, LaNi₅H₆, or FeTiH. Particularly suitable metal hydrides includes those having a plateau pressures within the reactor system 103 operating pressure. For example, metal hydrides having a plateau pressure from about 1 bar to about 5 bar are most suitable. With plateau pressures within the range of the operating pressure of the reactor system, additional compression of the hydrogen containing streams is not required. In one embodiment, the metal hydride in the ballast system 107 operates at a temperature at or above ambient temperature. This allows for heat integration with the reactor or hydrogen load (e.g. fuel cell). In one embodiment, the ballast system 107 is capable of adapting to differing loads of the reactor and to the changing load-demands of the hydrogen load 111 in addition to the startup and purification capabilities.

In one embodiment, the ballast system 107 receives hydrogen-containing stream 106 from the dehydrogenation reactor system 103. The metal hydride 303 selectively stores hydrogen from the hydrogen-containing stream 106. The metal hydride 303 provides hydrogen storage at a ballast pressure wherein the hydrogen storage capacity of the metal hydride reaches equilibrium. The ballast pressure is a pressure between the pressure of the hydrogen bad 11 and the dehydrogenation reactors system 103. When the pressure of the ballast system 107 is below the hydride equilibrium pressure (“plateau pressure”) at a given temperature, hydrogen is released. When the pressure of the ballast system 107 is above the plateau pressure, hydrogen is being stored. Suitable ballast pressures include pressures from about 1 bar to about 5 bar. In one embodiment, the ballast system 107 includes hydride that operates within the reactor's pressure range, for example, between 1 and 5 bar, or preferably between about 1-2 bar. The operating pressure of the ballast system 107 allows the hydride to provide passive control to the chemical reaction via backpressure. If all available ballasts within the ballast system 107 are full, the pressure in the system will increase, as pressure increases in the system the dehydrogenation reaction will slow down, thus preventing hydrogen waste. The metal hydride 303 in vessel 301 may be isolated or permitted to discharge hydrogen and any other gases present in the vessel 301. In one embodiment, the ballast system 107 selectively provides hydrogen to one or both of a hydrogen load 111 or the dehydrogenation system 100. In one operational mode, the ballast system 107 discharges purge stream 113 to the dehydrogenation reactor system 103. The purge stream includes hydrogen released from the metal hydride 303 and any impurity gasses that were not stored in the metal hydride 303. In another embodiment, the ballast system 107 discharges hydrogen product gas 109 to the hydrogen load 111 (see FIG. 1). In still another embodiment, the ballast system 107 discharges to both the dehydrogenation reactor system 103 and the hydrogen load 111. The discharge may be accomplished during operation or during start-up of the dehydrogenation reactor system 103. In one embodiment, the ballast system 107 selectively removes and stores hydrogen from the hydrogen-containing stream 106 and discharges the stream to the dehydrogenation reactor system 103 to remove the impurities not stored in the metal hydride 303. After the impurities are removed, the ballast system 107 begins discharging the hydrogen product gas 109 to the hydrogen bad 111, wherein the hydrogen product gas 109 has reduced or eliminated impurities. While the above has been described with respect to one vessel 301 containing metal hydride 303, the ballast system 107 may include multiple vessels 301, including three or more, arranged to provide desired functionality, such as simultaneous selective hydrogen storage and hydrogen discharge.

Control of the dehydrogenation system 100 is provided by a combination of flow control of the various product streams, temperature control within the dehydrogenation reactor system 103, catalyst loading and configuration and agitation within the zones of the dehydrogenation reactor system 103. The ballast system 107 further provides throttling of the hydrogen product flow to respond to demands for hydrogen by the hydrogen load 111.

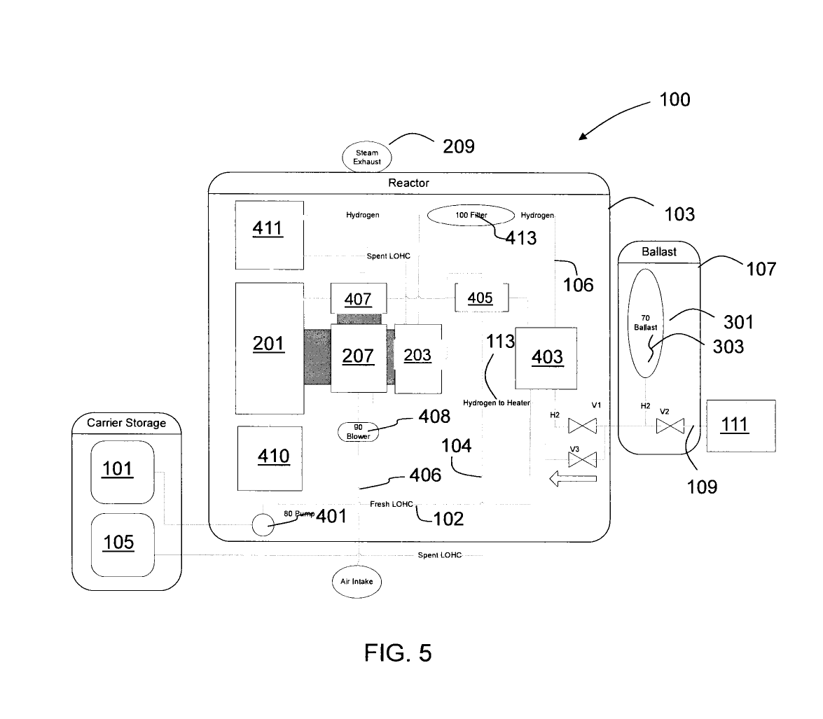

FIG. 4 shows an exemplary dehydrogenation system 100, according to an embodiment. In the diagram below, the fresh carrier starts in the liquid organic hydrogen carrier source 101 and is pumped by pump 401 through heat exchanger 403 where the heat of the incoming hydrogenated organic carrier 102 is exchanged with the hot out-going hydrogen-containing stream 106 exiting the dehydrogenation reactor system 103. This heat exchange serves to bring the hydrogen temperature into a range below 100° C., which is compatible with a fuel cell hydrogen load 111, while also beginning to pre-heat the incoming carrier. This heat exchange may also be integral to the carrier tank itself thus warming the bulk of the carrier. The carrier then flows through heat exchanger 405 where the outgoing dehydrogenated organic carrier 104 is heat-exchanged against the hydrogenated organic carrier 102. This heat exchange serves to further pre-heat the incoming hydrogenated organic carrier 102. In one embodiment, heat exchanger 405 is in the form of a dual pipe where the counter-flows are in thermal contact. Purge stream 113 is combined with an air intake stream 406 provided by blower 408, where the streams are combined to provide combustion in heater 207. The incoming hydrogenated organic carrier 102 flows through heat exchange 407 where the heat of the outgoing exhaust 209 from the heater 207 is exchanged against the incoming hydrogenated organic carrier 102. In one embodiment, heat exchanger 407 is integral to the heater manifold itself.

The incoming hydrogenated organic carrier 102 fluid then flows into reactor vessel 409 where incoming hydrogenated organic carrier 102 is mixed with catalyst at a temperature to dehydrogenate the incoming hydrogenated organic carrier 102 and liberate hydrogen. Agitation of the carrier is provided by agitator 410. In one embodiment, agitation is provided by an electromagnetically coupled agitator(s) and or ultrasonic means. The agitation means may be a simple stir-bar or beads or a rotary mechanism that also serves as a structured support for catalyst and also a gas-disengagement mechanism as well as a G-force mitigation system wherein the centripetal forces induced by the rotary motion are sufficient to prevent the reactor operation from being disrupted by accelerations experienced by the dehydrogenation system 100.

Within the reactor vessel 409, hydrogen generation may be enhanced by low-pressure zones and bubble nucleation zones. Low-pressure zones can be generated by fluid-flow over structures that cause selected low pressure zones. Bubble nucleation may be enhanced by designing structures or catalyst particle sizes in order to enhance bubble disengagement.

Once generated, the hydrogen is separated from the carrier in separator 411. The separator 411 may be comprised of the agitator and or de-misters or porous metals and ceramics as well as a tangential geometry within the separator 411. Hydrogen leaving the separator passes through filter mechanism 413 additionally removing impurities in the hydrogen stream. Impurities may be comprised of carrier vapor and or other impurities generated by the dehydrogenation process. The hydrogen-containing stream 106 is provided to the ballast system 107 and the ballast system 107 selectively stores the hydrogen and selectively delivers the hydrogen to the fuel cell hydrogen load 111 and/or the dehydrogenation reactor system 103 to generate heat.

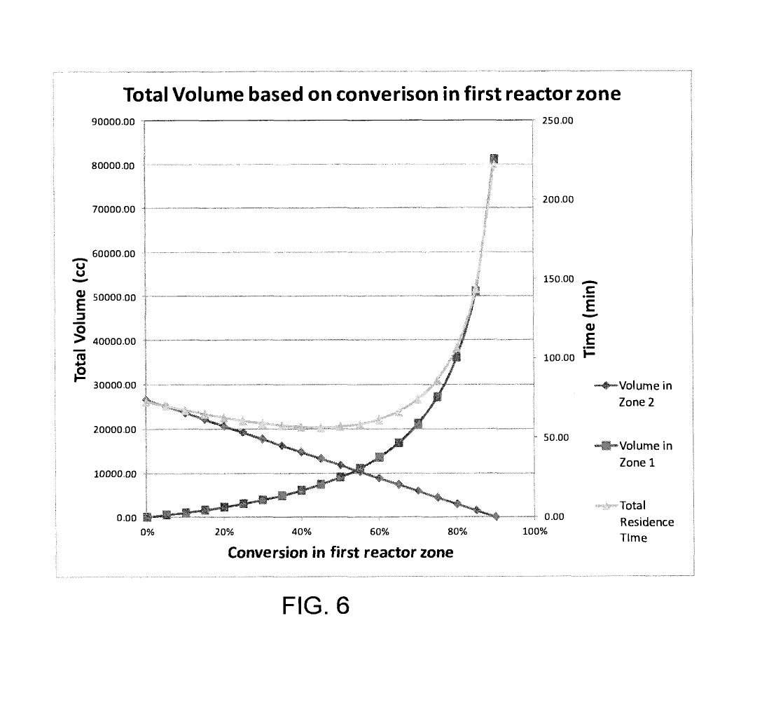

FIG. 5 shows an alternate embodiment, having a similar arrangement to the arrangement of FIG. 4. However, in place of the reactor vessel 409, the embodiment of FIG. 5 includes the first reaction zone 201 wherein the second reaction zone 205 is in thermal communication with the heater 207. In one embodiment, the second reaction zone 205 is a stirred-tank reactor or a ‘passive’ monolith or fixed-bed reactor. The ‘passive’ second reaction zone 204 saves weight and cost as simple fixed-bed reactor design. In one embodiment, due to a lower reaction rate in the second reaction zone 205 and different reacting species (molecules), the size of the second reaction zone 205 is larger, and the temperature and catalyst are different than the first reaction zone 201.

Having described the physical features of several embodiments of the inventive system, we now explain via examples the principles by which the inventive system attains its surprisingly good performance and the limitations imposed on certain features of the invention that enable the system to function most effectively.

### Examples

### LOHC Reactor Design

TABLE 2
SUMMARY OF DIFFERENT
REACTOR CONFIGURATIONS

| Scenario | Size (L) | Time to 90% (min) |
|---|---|---|
| Single tank | 39.10 | 106.80 |
| Two zones (diff temp.) | 20.60 | 56.30 |

Note:
Values are calculated using Excel 2007, volumes were calculated using equation 1.

Table 2 shows the relative sizes for two different reactor set-ups. The first is a single zone reactor and the second is a two zone reactor. The reaction conditions for the single tank reactor include a 2% (weight) slurry of 5% paladium on alumina catalyst (median particle size of 50 microns) for dehydrogenation of perhydro-N-ethylcarbazole hydrogen carrier at a temperature of 230° C., pressure of 1.5 bar, a liquid flow rate of 0.366 L/min of fresh carrier and a maximum reaction conversion of 90.0%. While the reaction conditions for the two zone reactor is shown in Table 3. As is shown in Table 2, using the same catalyst at two different temperatures significantly decreases the total volume size and time to reaction completion. While not wishing to be bound by theory, it is believed that the decreased total volume size and time is attributed to the increased reaction rates due to the increase in temperature in the second zone.

Using both a different catalyst and different temperature between the two zones, leads to a drastic decrease in reactor size and weight in comparison to the other cases. If the first zone contains a platinum catalyst (2% (weight) slurry of 5% platinum on alumina catalyst) at a temperature of 230° C. Platinum catalyst is used in the first zone because it has faster reaction kinetics than palladium. The second zone is operated at 240° C. and uses a palladium catalyst. Palladium is in the second zone since it has a higher reaction selectivity to the desired hydrogen product and reduces side reactions which can destroy the carrier and produce byproducts. Since palladium has slower kinetics compared to an equivalent amount of platinum using it in the higher temperature zone allows it to perform at a higher rate. The higher selectivity also allows for fewer byproducts to be generated at the higher temperature. This not only benefits the reactor but the total system, since the ballast/purification system will have to remove less contamination.

TABLE 3
CATALYST PROPERTIES
AND REACTION CONDITIONS

| Property | Value | Unit |
|---|---|---|
| Catalyst used (Both Zones) | Pd | |
| Temperature Zone 1 | 503 | K |
| Temperature Zone 2 | 513 | K |
| Reaction Rate Zone 1 | 0.0406 | 1/min |
| Reaction Rate Zone 2 | 0.1245 | 1/min |
| Initial Volumetric Flow Rate | 0.366 | L/min |
| Total Conversion | 90 | % |

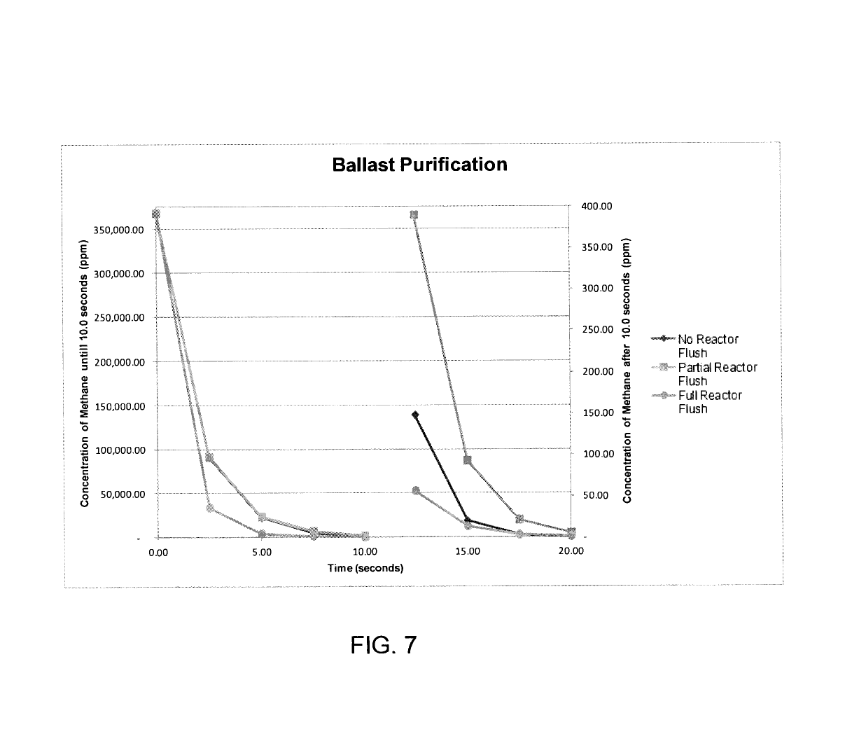

FIG. 6 shows the change in reactor sizes based on conversion in the first reactor zone, calculated in Excel 2007. Table 3 shows the catalyst properties used and certain system properties. The volume size of the reactors were calculated using equation 1. Equation 1 assumes the reactions follow a first order reaction rate.

$$V = ( \frac{{v}_{o}}{k} ) * ( \frac{x}{1 - x} ) \qquad ( 1 )$$

### Where:

### V=Volume of Reactor (L)

vₒ=Initial volumetric flow rate into reactor 1 (L/min)
k=reaction rate (1/min)
x=Reaction conversion

FIG. 6 shows that as you increase the conversion in the first reactor, the total system volume changes to give a minimum at a certain point. If you compare the two extremes (Reactor 1 at 90% conversion and Reactor 2 @0% conversion) to the minimum volume point, there is a significant reduction in reactor size. The results indicate that the minimum total volume point is the point where the two zones are roughly equivalent in size.

A ballast system using a metal hydride offers unique advantages to the efficient operation of the overall hydrogen storage system. Foremost, it allows the system to both store and purify hydrogen in a single unit. This saves overall system weight due to less equipment. Unlike a PSA, the hydrogen reacts with the hydride. If a hydride is chosen with a equilibrium pressure of about 1.5 bar at the operating temperature, the system operates without the need of compressors since the reactor operates at about 1-5 bar and the fuel cell/heater require hydrogen at about 1 bar. The ballast system according to the present disclosure can passively regulate the reactors output. If the ballast starts to overfill, the pressure in the reactor will increase, and subsequently slow down and eventually stop the hydrogen generation (i.e. the dehydrogenation reaction will come to equilibrium). The incorporation of the hydride ballasts also allows the system to have an instant start. Since the reactor takes time to heat-up and start producing hydrogen, prefilling the ballast with hydrogen allows the system to instantaneously deliver hydrogen to both the heater and the fuel cell.

### Start Up Modes—Ballast Dimensions Based on Start Up Type

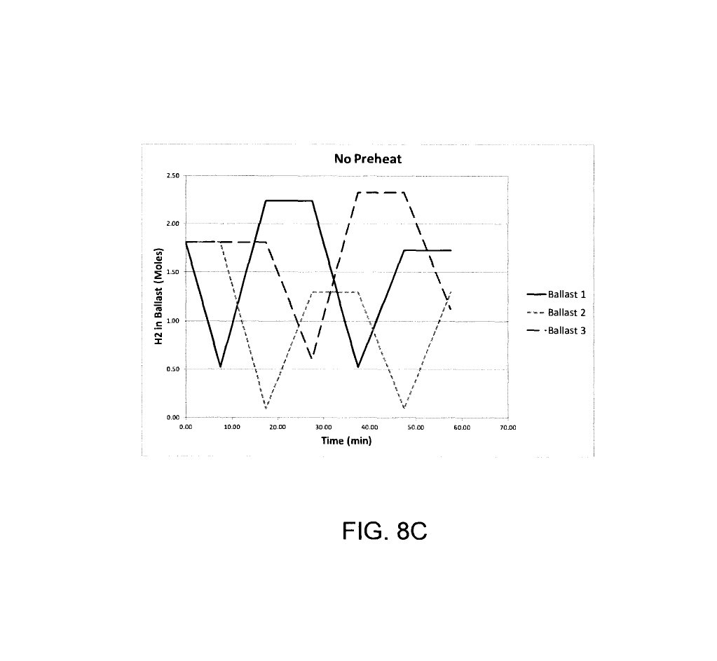

There are three prominent start-up conditions which the ballasts could be adjusted for. The three start-up conditions are, Cold, Medium and no pre-heat. The “Cold” start-up condition refers to the ballast providing the initial hydrogen to heat up the reactor and to feed the fuel cell. The “Medium” condition refers to the ballast providing the initial energy only to heat up the reactor. This condition implies that the fuel cell does not need to start instantaneously. The last start-up condition, “no pre-heat” implies that the reactor has an external source to preheat the vessel. The ballast initially only supplies the fuel cell with hydrogen while the reactor is heating up. Since the initial demand for each condition is different, the size of the ballast in each case is different. Table 4A identify the parameters used to calculate FIGS. 8A-8C in Excel 2007 for a 15 kw reactor. Table 4B shows the size of the ballast calculated using the parameters in table 4A in Excel 2007. The process in which these ballasts interact with each other is synonymous to a pressure swing adsorption cycle. As one of the ballasts fills, another is purifying and one is feeding to the system.

TABLE 4A
SYSTEM CONDITIONS

| | | |
|---|---|---|
| Fuel Cell | 0.029 | MW |
| Heater-Steady State | 0.012 | MW |
| Heater-Start Up | 0.073 | MW |
| Reactor weight | 2549 | g |
| Catalyst weight | 23.0 | g |
| Carrier in reactor | 18,982.0 | g |
| Number of Ballasts | 3 | |
| Hydride Density | 1.45 | g/cm3 |
| Hydride Wt % | 1.4 | % |
| Temperature | 25 | ° C. |
| Pressure | 1.5 | atm |
| Ballast void space | 20 | % |
| Ballast Drain | 90 | % |

Note:
Ballast Drain refers to how full the ballast is once the ballast is considered empty, with 100% being empty and 0% being full.

The weights indicated in table 4A were used to determine the thermal mass

TABLE 4B
BALLAST SIZE AND WEIGHTS

| | Cold | Medium | No preheat | Units |
|---|---|---|---|---|
| Metal Volume | 37.60 | 30.60 | 10.85 | cc |
| Metal Weight | 305.00 | 248.00 | 87.87 | g |
| Hydride Weight | 5,074.00 | 3,720.00 | 775.66 | g |
| Hydrogen | 71.00 | 52.00 | 10.86 | g |
| Total Weight | 5,450.00 | 4,020.00 | 874.39 | g |

Notes:
The FC is operating at a 50% efficiency
Start-up time is 1 minute
Purification Time is 15/15/20 seconds respectively

The amount of hydride required for the cold and medium start up is determined by the amount of hydrogen needed to go from start up into steady state. This amount is determined by taking the hydrogen needed to power the fuel cell and the heater during start up and then to increase that minimum amount to allow the system to have enough hydrogen to transition into steady state operation. For the cold and medium start up the minimum amount of hydrogen is increased to allow ballast 3 (in a three ballast system) to run for an additional 20 seconds while ballast 1 and 2 fill for 5 seconds and ballast 1 then purifies for 15 seconds. For the no preheat case the amount of hydride required is determined based off the steady state hydrogen requirements of the fuel cell and the heater to operate for 30 seconds. Once the initial amount of hydrogen is determined FIG. 8A-8C are determined by adding or subtracting the hydrogen in each ballast based on what part of the cycle the ballast is in. For example if ballast 1 is giving hydrogen to the fuel cell, it is losing the amount of hydrogen it takes to deliver that power requirement. If ballast 1 is being charged by the reactor 1 is receiving the amount of hydrogen being produced from the reactor.

It is shown by FIGS. 8A and 8B that the cold and medium start-up conditions have roughly the same trend. This is due to the fact that they operate the same way but the thermal loading they need to compensate for is different, which translate into different sizes. The no preheat condition, FIG. 8C is an example of rapidly swapping between each ballast. Since the ballast system is sized for the steady state energy consumption, the ballasts do not experience a wait time after they are drained.

### PSA—Ballast for the LOHC Reactor

Using the same set up as the cold start up in the prior example, a ballast system is configured as a novel pressure-swing adsorption PSA system of metal hydride. Whereas conventional PSA systems require a compressor, the ballast system that includes hydrides that have a pressure-plateau in-between the operating pressure of the reactor and the fuel cell run without compressors. Table 4B shows the specifications for a metal hydride system for a 15 kW reactor running a cold start up.

Since the hydrogen coming out of the reactor may not achieve the desired level of purity, the metal hydride ballasts can be used to purge impurity gasses to purify the hydrogen prior to sending it to the fuel cell. The system acts as a pressure-swing adsorption system with the hydride selectively storing the hydrogen but not the impurities. Once the impurities build-up, they are purged into the reactor system where they contribute heat to the reactor through combustion of the impurities. The impurities are purged to the reactor system for a time sufficient to provide a desired impurity level at the ballast system, the desired impurity level corresponding to the operation of the hydrogen load 111. For example, the impurity level may an impurity level below the maximum impurity level for the input of the fuel cell. The two methods of purging the ballasts are to purge the ballast head space with product from the reactor to the heater or to purge with regenerated hydrogen while powering the heater for a short time prior to powering the fuel cell.

An exemplary system includes three metal hydride ballasts. FIG. 8A shows how the hydrogen in the ballast changes over time. Initially, all three ballasts are used to heat up the reactor. Once the reactor is warmed up, ballast 1 fills for a short period of time from the reactors output while ballasts 2 and 3 deliver hydrogen to the system. Then as ballast 1 is purifying (using part of the reactor's production), ballast 2 is filling with the excess hydrogen coming from the reactor and ballast 3 is delivering hydrogen to the fuel cell. This pattern alternates so that one ballast is always filling while another is delivering hydrogen to the fuel cell and the heater.

Table 5 shows properties for calculations in purification modes in Table 6.

TABLE 5
BALLAST PROPERTIES

| | | |
|---|---|---|
| H2 in Ballast | 16.67 | moles of H2 |
| Hydride Density | 1.45 | g/cm3 |
| Hydride Wt % | 1.4 | % |
| Hydride Weight | 2.38 | kg of Hydride |
| Hydride Volume | 1.64 | L |
| Head Space Void | 20 | % |
| Head Space | 0.41 | L |
| Ballast Volume | 2.05 | L |
| Temperature | 150 | C |

TABLE 6
COMPARISON OF BALLAST PURIFICATION MODES
Mode 6A—No Flush

| | | |
|---|---|---|
| Contamination (ppm) | 100 | 1000 |
| Purge Time (sec) | 17.5 | 20 |
| State of Charge (%) | 95.70 | 94.90 |

Mode 6B—Full Reactor Flush

| | | |
|---|---|---|
| Contamination (ppm) | 100 | 1000 |
| Purge Time (sec) | 15.00 | 20.00 |
| State of Charge (%) | 99.20 | 98.60 |

Mode 6C—Partial Reactor Flush

| | | |
|---|---|---|
| Contamination (ppm) | 100 | 1000 |
| Purge Time (sec) | 17.5 | 22.5 |
| State of Charge (%) | 99.20 | 98.60 |

Table 6, including modes 6A-6C, compare different purification modes for a single ballast based off Table 5. The purification modes are, no flush, full reactor flush and partial reactor flush. In No Flush Mode, Mode 6A, the headspace in the ballast is purified by the hydrogen desorbing from the hydride and the hydrogen-containing stream is sent to the heater, burning the contaminants. The Full/Partial Reactor Flush, Modes 6B and 6C, use the full/partial reactor effluent to flush the headspace of the ballast. In these modes the ballast is not desorbing hydrogen while the reactor effluent is flowing through. In both cases the reactor flushes until the contaminants in the headspace are on the same order of magnitude as the reactor effluent, then these cases behave as the no flush mode. A “well mixed” model is assumed in all cases. This means that when hydrogen and any contaminants enter the headspace of the ballast, whether it be from the hydride or the reactor, the contents are completely mixed and then mixed material leaves the ballast. The “State of Charge” parameter is a relation of how full the ballast is to its maximum capacity. To determine the ballast pressure and relate it to how full it is the values in Table 7 were used.

TABLE 7
BALLAST FILL BASED ON PRESSURE

| Ballast fill | Ballast Pressure (atm) |
|---|---|
| 0% | 0 |
| 5% | 1.35 |
| 95% | 1.65 |
| 100% | 5 |

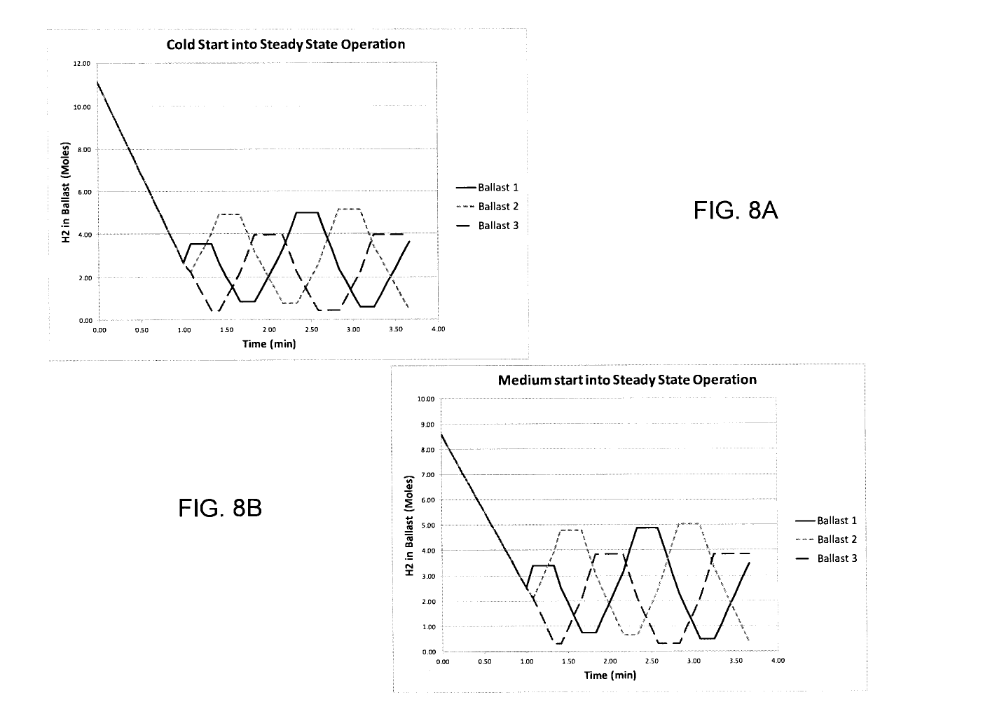

As Table 6 shows, a Partial Flush (Mode 6C) And no flush take roughly the same amount of time but a partial flush allows the ballast to have a higher state of charge, Full Reactor Flush, Mode 6B, works in the least amount of time. However, in the Full Reactor Flush, a large amount of fuel to the reactor at short time periods which may cause temperature spikes. FIG. 7 shows the purification over time for a ballast which is filled with 100 ppm of methane contamination. As the figure shows that all three curves follow the same pattern with the no reactor flush/partial reactor flush behaving roughly the same. When the contaminants in the reactor effluent are high, the ballast cannot be fully charged since the contaminants in the headspace would greatly increase the ballast pressure.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A process for releasing hydrogen from a hydrogenated organic carrier comprising:
(a) providing a reactor system comprising a first reaction zone and a second reaction zone, the first reaction zone having a first reaction condition and the second reaction zone having a second reaction condition;
(b) introducing said hydrogenated organic carrier in liquid form to the first reaction zone of the reactor system and exposing the hydrogenated organic carrier to the first reaction condition;
(c) partially dehydrogenating said organic carrier in the first reaction zone of the reactor system whereby said dehydrogenating produces hydrogen and a liquid phase partially dehydrogenated organic carrier;
(d) separating hydrogen and the partially dehydrogenated organic carrier;
(e) introducing the partially dehydrogenated organic carrier into the second reaction zone and exposing the partially dehydrogenated organic carrier to the second reaction condition;
(f) dehydrogenating the partially dehydrogenated organic carrier in the second reaction zone of the reactor whereby said dehydrogenating produces hydrogen and a liquid phase dehydrogenated organic carrier;
(g) separating hydrogen and said liquid phase dehydrogenated organic carrier;
(h) introducing the hydrogen from the first reaction zone and the second reaction zone to a ballast system;
wherein the first reaction condition and the second reaction condition are different and include an elevated temperature provided by a heater.

2. The process of claim 1, wherein the first reaction condition and the second reaction condition differ in catalyst.

3. The process of claim 1, wherein the first reaction condition and the second reaction condition differ in temperature.

4. The process of claim 1, wherein the first reaction condition and the second reaction condition differ in catalyst and temperature.

5. The process of claim 1, wherein the hydrogenated organic carrier is an aromatic hydrocarbon selected from the group consisting of benzene, toluene, naphthalene, anthracene, pyrene, perylene, fluorene, indene, and combinations thereof.

6. The process of claim 1, wherein the hydrogenated organic carrier is selected from the group consisting of a pi-conjugated substrate, including aromatic compounds with one or two rings; polycyclic aromatic hydrocarbons; pi-conjugated substrates with nitrogen heteroatoms; pi-conjugated substrates with heteroatoms other than nitrogen; pi-conjugated organic polymers or oligomers; ionic pi-conjugated substrates; pi-conjugated monocyclic substrates with multiple nitrogen heteroatoms; pi-conjugated substrates with at least one triple-bonded group; selected fractions of coal tar or pitch that have as major components the above classes of pi-conjugated substrates; and combinations thereof.

7. The process of claim 1, wherein the hydrogenated organic carrier is selected from the group consisting of N-methylcarbazole, N-ethylcarbazole, N-n-propylcarbazole, carbazole, N-iso-propylcarbazole, perhydro-fluorene, and combinations hereof.

8. The process of claim 1, wherein the hydrogenated organic carrier is further provided as a heat exchange fluid to provide temperatures for catalytic dehydrogenation to one or both of the first reaction zone and the second reaction zone.

9. The process of claim 1, wherein the catalyst present in the first reaction zone and the second reaction zone are independently selected from metals and alloys selected from titanium, zirconium, tantalum, niobium, molybdenum, tungsten, iron, ruthenium, cobalt, rhodium, iridium, nickel, palladium, platinum, vanadium and combinations thereof.

10. The process of claim 1, wherein the catalyst present in the first reaction zone and the second reaction zone are independently palladium-containing catalysts, platinum-containing catalysts, or combinations thereof.

11. The process of claim 1, wherein the ballast system include a metal hydride.

12. The process of claim 11, wherein the metal hydride is a hydride complex or alloy capable of selective hydrogen storage.

13. The process of claim 11, wherein the metal hydride is selected from the group consisting of Mg(BH₄)₂, NaBH₄, NaAlH₄, LaNi₅H₆, FeTiH and combinations thereof.

14. The process of claim 11, wherein the ballast system including the metal hydride operates within the pressure range of the first reaction condition and the second reaction condition.

15. The process of claim 11, further comprising directing a purge stream from the ballast system to the heater of the dehydrogenation reactor, the purge stream comprising gaseous impurities that were not stored by the metal hydride.

16. The process of claim 15, wherein the purge stream is directed for a time sufficient for the amount of impurity in the ballast system to be reduced to a predetermined impurity level, the predetermined impurity level corresponding to the operation of a hydrogen load.

17. The process of 16, wherein at least a portion of the hydrogen from the first reaction zone and the second reaction zone is combined with the purge stream to the heater, further diluting the impurities in the ballast system.

18. The process of claim 1, further comprising directing at least a portion of the hydrogen from the first reaction zone and the second reaction zone to the heater of the dehydrogenation reactor.

19. The process of claim 1, wherein one or both of the first reaction zones and the second reaction zone includes agitation.

20. The process of claim 1 where the heater comprises a catalytic combustor.

21. The process of claim 19, wherein the agitation includes agitation by agitator, circulator or ultrasonic energy.

22. A dehydrogenation system for releasing hydrogen from a hydrogenated organic carrier comprising:
a reactor system comprising a first reaction zone and a second reaction zone, the first reaction zone being arranged and disposed to provide a first reaction condition and the second reaction zone being arranged and disposed to provide a second reaction condition, the first reaction condition and the second reaction condition being different and including an elevated temperature provided by a heater;
the first reaction zone of the reactor system being arranged and disposed to partially dehydrogenate a liquid phase hydrogenated organic carrier in the first reaction zone to form hydrogen and a liquid phase partially dehydrogenated organic carrier;
the second reaction zone of the reactor system being arranged and disposed to dehydrogenate the liquid phase partially dehydrogenated organic carrier in the second reaction zone to form hydrogen and a liquid phase dehydrogenated organic carrier;
a ballast system arranged and disposed to receive the hydrogen from the first reaction zone and the second reaction zone.

23. The system of claim 22, wherein the ballast system include a metal hydride.

24. The system of claim 23, wherein the metal hydride a hydride complex or alloy capable of selective hydrogen storage.

25. The system of claim 23, wherein the metal hydride is selected from the group consisting of Mg(BH₄)₂, NaBH₄, NaAlH₄, LaNi₅H₆, FeTiH and combinations thereof.

26. The system of claim 23, wherein the ballast system including the metal hydride operates within the pressure range of the first reaction condition and the second reaction condition.

27. The system of claim 22, wherein the catalyst in the second reaction zone includes a structured catalyst.

28. The system of claim 22, wherein the catalyst present in the first reaction zone and the second reaction zone are independently selected from metals and alloys selected from titanium, zirconium, tantalum, niobium, molybdenum, tungsten, iron, ruthenium, cobalt, rhodium, iridium, nickel, palladium, platinum, vanadium and combinations thereof.

29. The system of claim 28, wherein the catalyst present in the first reaction zone and the second reaction zone are independently paladium, platinum, or combinations thereof.

30. The system of claim 22, wherein one or both of the first reaction zone and the second reaction zone includes an agitator.

31. The system of claim 30, wherein the agitator includes a catalyst.

32. The system of claim 22, wherein the total volume of the first reaction zone and the second reaction zone is less than the volume of a single vessel of the same dehydrogenation efficiency.

33. A dehydrogenation system for releasing hydrogen from a hydrogenated organic carrier comprising:
a reactor system comprising a reaction zone, the reaction zone being arranged and disposed to provide a reaction condition, the reaction condition including an elevated temperature provided by a heater;
the reaction zone of the reactor system being arranged and disposed to dehydrogenate a liquid phase hydrogenated organic carrier in the reaction zone to form hydrogen and a liquid phase dehydrogenated organic carrier;
a ballast system having at least one vessel containing metal hydride capable of selectively storing hydrogen from the hydrogen-containing stream and being arranged and disposed to provide hydrogen to one or both of a hydrogen load or the dehydrogenation reactor system.

34. A process for providing a hydrogen-containing stream comprising:
(a) forming a hydrogen-containing stream with a dehydrogenation reactor system;
(b) providing the hydrogen-containing stream to a ballast system having at least one vessel containing metal hydride;
(c) selectively storing hydrogen with the metal hydride from the hydrogen-containing steam;
(d) selectively providing the hydrogen to one or both of a hydrogen load or the dehydrogenation reactor system.

35. The process of claim 34, wherein the selectively storing includes storing hydrogen with the metal hydride and permitting impurity gases that are not stored in the metal hydride to be separated by the metal hydride.

36. The process of claim 35, wherein the selectively providing includes directing a purge stream containing the impurity gases to a heater within the dehydrogenation reactor.

37. The process of claim 36, wherein the directing a purge stream includes a full reactor flush, a partial reactor flush or no reactor flush.

38. The process of claim 36, wherein the purge stream is directed for a time sufficient for the amount of impurity in the ballast system to be reduced to a predetermined impurity level, the predetermined impurity level corresponding to the operation of a hydrogen load.

39. The process of 36, wherein at least a portion the hydrogen-containing stream is combined with the purge stream to the heater to further dilute the impurities in the ballast system.

40. The process of claim 34, wherein the selectively providing includes providing hydrogen during start-up of dehydrogenation reactor system.

41. The process of claim 34, wherein the selectively providing includes providing hydrogen during a shift in hydrogen load.

42. The process of claim 34, wherein the ballast system includes a plurality of vessels containing the metal hydride.

43. The process of claim 34, wherein the ballast system including the metal hydride operates within the pressure range of the dehydrogenation reactor system.

44. The process of claim 34, further comprising simultaneous storing and discharging of hydrogen with the ballast system.

45. The process of claim 34, further comprising, prior to the forming a hydrogen-containing stream, the ballast system is loaded with sufficient hydrogen to start up the dehydrogenation reactor system.

46. The process of claim 34, further comprising storing sufficient hydrogen with the ballast system to permit restart after shutdown of the dehydrogenation system and shutting down the dehydrogenation system.

47. A dehydrogenation system for providing a hydrogen-containing stream comprising:
a dehydrogenation reactor system arranged and disposed to dehydrogenate a carrier to form a hydrogen-containing stream;
a ballast system having at least one vessel containing metal hydride capable of selectively storing hydrogen from the hydrogen-containing stream and being arranged and disposed to provide hydrogen to one or both of a hydrogen load or the dehydrogenation reactor system.

48. The system of claim 47, wherein the metal hydride a hydride complex or alloy capable of selective hydrogen storage.

49. The system of claim 48, wherein the metal hydride is selected from the group consisting of Mg(BH₄)₂, NaBH₄, NaAlH₄ LaNi₅H₆, FeTiH and combinations thereof.

50. The system of claim 47, wherein the ballast system including the metal hydride operates within the pressure range of the dehydrogenation reactor system.

51. The system of claim 47, wherein the ballast system includes a plurality of vessels containing the metal hydride.

52. The system of claim 51, wherein the plurality of vessels are arranged and disposed to provide simultaneous storing and discharge of hydrogen.
